(19) United States
(12) Patent Application Publication
(10) Pub. No.: US 2008/0091414 A1
(43) Pub. Date: Apr. 17, 2008

(54) Perceptible signals giving an impression of continuous pace change

(76) Inventor: Guy Madison, Storvreta (SE)

Correspondence Address: DOUGLAS T. JOHNSON;MILLER & MARTIN, 1000 VOLUNTEER BUILDING, 832 GEORGIA AVENUE, CHATTANOOGA, TN, 37402-2289, US

(21) Appl. No.: 11/985,479

(22) Filed: Nov. 15, 2007

(30) Foreign Application Priority Data
May 11, 2006 (SE) PCT/SE2006/050117

(51) Int. Cl. G06F 15/00

(52) U.S. Cl. 704/200

(57) ABSTRACT

A perceptible signal is provided, which is a repetition of a time-limited perceptible signal sequence. The time-limited perceptible signal sequence comprises at least two sets of signal elements, each of which constituting a general trend in signal characteristics as well as interval. The general trend in the end of one set agrees essentially with the general trend in the beginning of another set within the time-limited signal sequence. When the sequences are repeated, a transfer between sets of signal elements becomes essentially unnoticeable, creating perceived signal sequences extending over several sequence intervals. In one aspect of the present invention, a mammal can be exposed for such a perceptible signal. In another aspect of the present invention, a memory device has a representation of such perceptible signals stored for enabling an easy retrieval of the perceptible signal.

The present invention relates in general to methods and devices for generation of perceptible signals, and in particular to such signals that are suitable for stimulating the sympathetic and/or parasympathetic nervous systems.

### BACKGROUND OF THE INVENTION

Many visceral functions of the human body are controlled, at least partly, by the autonomic nervous system. Such functions are not possible to control directly by conscious acts, but are instead controlled by the sympathetic and parasympathetic nervous system. Examples of organs influenced by the sympathetic and parasympathetic nervous system are the eyes, sweat glands, the heart, the lungs, the gut, the skin and the blood. The sympathetic and parasympathetic nervous systems are stimulated by different body sensors, but are also influenced by outer stimuli. The sympathetic nervous system is e.g. involved in different alarm reactions connected to the “fight or flight reaction”. The parasympathetic nervous system is typically responsible for relaxing and recovering processes.

It is well known in prior art that different kinds of perceptible signals, such as sound or light, can influence the sympathetic and parasympathetic nervous systems. Music is e.g. known to have a relaxing effect, and is frequently used for assisting people to calm down (e.g., Barker, 1991; Guzzetta, 1989). Such effects are believed to be mainly controlled by the parasympathetic nervous systems. Athletes do often expose themselves for soft music before a competition, in particular in sports requiring a high level of concentration. Similarly, stimulating signals having a high pace or amplitude can also be used for assisting the sympathetic nervous system to create arousal, e.g. by athletes that may benefit from the sympathetic alarm reactions. In particular, rhythmic signals seem to be efficient in stimulating the sympathetic and parasympathetic nervous systems (for a review see Bartlett, 1996).

### SUMMARY OF THE INVENTION

A general object of the present invention is to provide improved stimulation of the sympathetic and/or parasympathetic nervous systems of mammals.

The above object is provided by methods and devices according to the enclosed patent claims. In general words, a perceptible signal is provided which is a repetition of a time-limited perceptible signal sequence. The time-limited perceptible signal sequences comprise at least two sets of signal elements, each of which constitutes a general trend in certain signal characteristics as well as in the time intervals between elements. These intervals are related to the perceived pace of signal elements. The general trend in the end of one set of signal elements agrees essentially with the general trend in the beginning of another set of signal elements within the time-limited signal sequence. When the time-limited perceptible signal sequences are repeated, the boundaries between sets of signal elements are hence essentially unnoticeable for a person being exposed to the signals. In one aspect of the present invention, a mammal can be exposed for such a perceptible signal. In another aspect of the present invention, a memory device has a representation of such perceptible signals stored for enabling an easy retrieval of the perceptible signal.

An advantage with the present invention over prior art is that it provides a perceptible signal giving an impression of a continuous and infinite pace change.

### BRIEF DESCRIPTION OF THE DRAWINGS

The particular features and advantages of the invention as well as other objects will become apparent from the following description taken in connection with the accompanying drawings in which:

FIGS. 1A-C are diagrams illustrating sequences of signal elements;

FIG. 2A is a diagram illustrating an embodiment of a time-limited sequence of signal elements according to the present invention;

FIG. 2B is a diagram illustrating a signal sequence composed by a number of time-limited sequence of signal elements according to FIG. 2A;

FIG. 3 is a diagram illustrating another embodiment of a time-limited sequence of signal elements according to the present invention;

FIG. 4 is a diagram illustrating yet another embodiment of a signal sequence according to the present invention;

FIG. 5A is a schematic block scheme of an embodiment of a signal generator for acoustic signals according to the present invention;

FIG. 5B is a schematic block scheme of another embodiment of a signal generator for acoustic signals according to the present invention;

FIG. 5C is a schematic block scheme of yet another embodiment of a signal generator for acoustic signals according to the present invention;

FIG. 6 is a schematic block scheme of an embodiment of a signal generator for light signals according to the present invention;

FIG. 7 is a schematic block scheme of an embodiment of a signal generator for electric signals according to the present invention;

FIG. 8 is a schematic block scheme of an embodiment of a signal generator for tactile signals according to the present invention;

FIGS. 9A-B are flow diagrams of main steps of embodiments of methods according to the present invention.

### DETAILED DESCRIPTION OF THE PREFERRED EMBODIMENT

In the detailed description below, most examples are directed to use of audio signal. However, the present invention is possible to implement using any kind of signal perceivable by mammals. Non-exclusive examples are audio signals, light signals, electrical signals, and tactile signals.

Throughout the present disclosure, some important terms are used. In order to reduce any possibility for misinterpretations, the most critical terms are defined below.

“Pace” is in the present disclosure defined as the subjective number of stimulus events per unit time. In other words, pace is the reciprocal of subjective inter-event interval. Pace is therefore to be considered as a frequency measure.

“Interval” is used to denote the physical time lapsed between two events, defined as the time between corresponding portions of the two events, e.g. the time of a maximum intensity, the actual onset of the event, etc.

“Rate of change” is used for characterizing the fastness of a change of e.g. pace or interval, per time unit or per event. In a mathematical view, rate of change corresponds to the derivative of the considered quantity with respect to time or event.

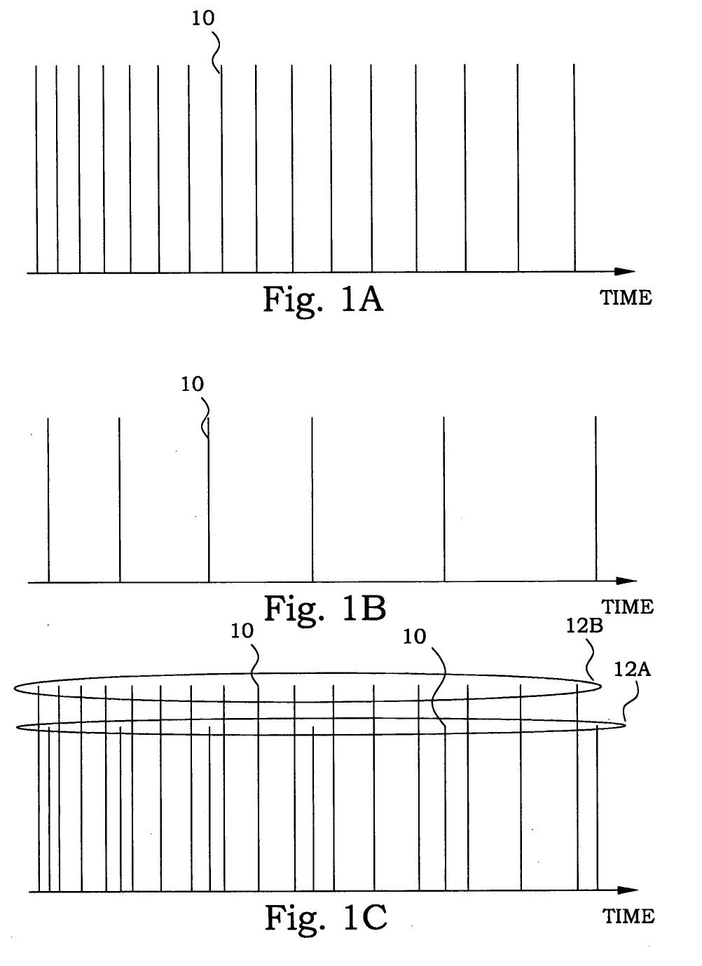

One of the ideas leading to the present invention is to use a signal that creates a subjective pace change. Decreasing the pace is believed to influence the parasympathetic nervous system in a relative efficient manner. A typical reaction of such a slowing-down signal pace is relaxation and increased sense of wellbeing. In FIG. 1A, a diagram illustrates such a slowing-down signal sequence. Each line 10 represents the occurrence of a signal element. In the beginning of the sequence, the pace is high, while the pace is lower at the end.

In FIG. 1B, another signal sequence is illustrated, having a lower pace. When the retardation of the signal pace proceeds, the intervals will eventually be so long that a mammal cannot perceive them as a regular pace. A typical upper limit for the time between two solitary events in a sequence still perceived as being temporally related, so as to create the experience of pulse or rhythm, is on the order of 2 s. The pace can neither be too fast, since the individual events then tend to create a continuous perception. A typical lower limit for the time between two stimulus events in a sequence still perceived as separate events is on the order of 100 ms.

A signal sequence can also comprise several alternative paces at the same time. In FIG. 1C, the signal sequences of FIG. 1A and FIG. 1B are merged into a composite signal sequence. Also such a composite signal sequence, having two sets 12A, 12B of signal elements, where the different components exhibit a pace change within its own set 12A, 12B, will be perceived as a retarding or slowing-down signal. Preferably, the components of such a composite signal are phase-locked and exhibit a small-integer interval relation, such as e.g. 1:2, 1:3, 1:4, 2:3, etc. The composite signal will then easier be perceived as one complex pace-changing signal.

As mentioned above, subjective pulses can only be perceived within certain limits. A problem with creating signals with changing pace is therefore that a sustained sequence will eventually exceed these limits: the higher the rate of change, the shorter the usable sequence. Sequences with a noticeable amount of change are typically limited to 1 or 2 minutes in length. However, general relaxation processes are typically longer than that and require longer signal sequences.

The present invention solves that requirement by repeating time-limited signal sequences having certain properties, which will be explained in detail below. It does so by creating an illusion of infinite pace change across many repeated time-limited sequences, although the density of perceivable events, Le. those above any sensory threshold, in each sequence is approximately constant.

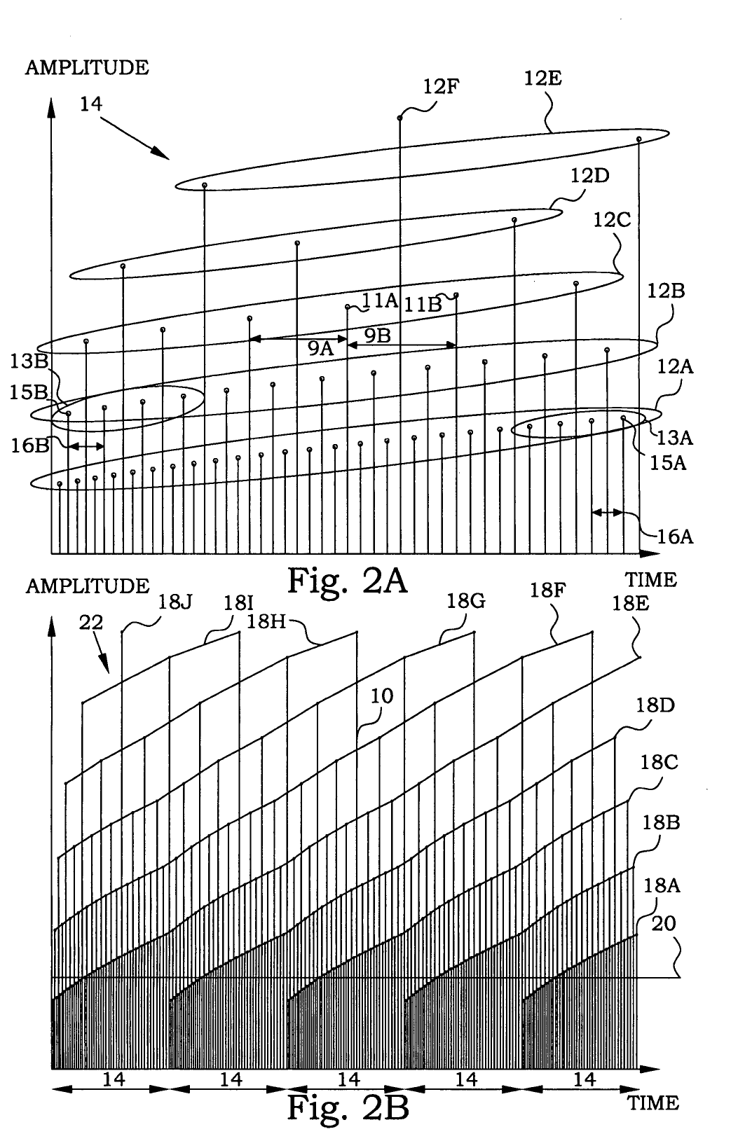

FIG. 2A depicts an embodiment of a time-limited signal sequence according to the present invention. In this embodiment, the signal elements are arbitrary audio signals of a relatively short duration, i.e. a duration short enough for the signals to be perceived as separate sound events. The amplitude of the signal elements is related to their position in the time-limited sequence. One immediately notices that the signal sequence consists of a number of sets of signal elements distinguished by their difference in absolute amplitude and interval, and defined by their common trends in amplitude and interval. Each set of elements thus forms a signal sequence having a certain trend in amplitude and time. A first set 12A of signal elements comprises the signal elements having the lowest amplitudes. A second set 12B of signal elements comprises signal elements having a somewhat higher amplitude. In this embodiment, six sets 12A-F of signal elements are present. Nearest neighboring signal elements in each set have similar amplitudes 11A, 11B, however, not exactly identical. Furthermore, the time difference 9A, 9B to the two nearest neighbors in the same set are also similar, but generally not exactly equal. Set 12F consists in this embodiment of a single signal element. In the present embodiment, within each set, the amplitude increases monotonically within each set as the intervals increase.

The mammalian auditory system readily detects periodicities or quasi-periodicities in simple and complex sound sequences. Periodicities in the range 50 μs to 50 ms are perceived as audio frequency (pitch), the range 50 ms to 250 ms as “motorboating”, and the range 250 ms to approximately 1.5 s as pulse (e.g. Warren et al., 1991). The perception of pulse is more acute in an optimal range from approximately 500 to 800 ms. Stimulation via other sensory organs is likely to be processed in a similar fashion and can therefore be assumed to yield qualitatively similar sensations in response to similar interval ranges. The sensory system will therefore by design relate signal elements having approximately the same amplitude and occurring at approximately the same intervals within the pulse range. The sets 12A-F of FIG. 2A will typically be interpreted as overlaid and/or interleaved signal sequences, in analogy with the composed sequence of FIG. 1C, and produce a perception of a pulse with a certain pace, most likely in the optimal range. In the signal sequence of FIG. 2A, both pace and amplitude varies slowly during the time-limited sequence. This variation is, however, slow enough not to disturb the interpretation of the different sets. In preferred embodiments, the signal elements of the individual sets of signal elements occur at a continuously and monotonically changing intervals. However, even if a few signal elements are removed or exhibit a different local interval, the general trend is enough for supporting the impression of a continuous pulse with a certain pace. The majority of signal elements of the sets of signal elements should therefore occur with continuously and monotonically changing intervals. In preferred embodiments, the signal elements in each set of signal elements have continuously and even more preferably monotonically changing amplitudes within the time-limited sequence of signals.

The signal sequence of FIG. 2A can be considered as being formed in different manners. One way to view the entire signal sequence is as one signal having elements of varying amplitudes and time differences. Some of these signals may then by a listener be collected into different sets having the above described properties. Another way to view the signal is that it is a signal sequence composed by overlaid part signal sequences, each one corresponding to the above described sets. Note that both overlaid sequences and a single sequence are equivalent within the definition of present invention in terms of both physical and perceived properties.

FIG. 2B depicts five consecutive time-limited signal sequences 14 according to FIG. 2A. Below, references are made to both FIGS. 2A and 2B. It is here easily seen that the end of a particular set of signal elements in one time-limited sequence 14 matches the beginning of another set of signal elements in the following time-limited sequence. A general trend in the end part of the time-limited sequence 14 should therefore resemble a general trend in the beginning part of the time-limited sequence 14. More specifically, a general trend of signal element amplitude and interval of the signal elements 10 of a first set in an end part 13A of the time-limited sequence 14 of signals is similar to a general trend of signal element amplitude and interval of the signal elements 10 of a second set in a beginning part 13B of the time-limited sequence 14 of signals. Preferably, a last signal element 15A of one set of signal elements within the time-limited sequence 14 of signals has similar signal characteristics, in this case similar amplitude, as a first signal 15B element of another set of signal elements. Also, preferably, a time difference 16A between a last pair of signal elements of one set of signal elements within the time-limited sequence 14 of signals is close to a time difference 16B between a first pair of signal elements of another set of signal elements. This leads to the impression that one set transfers into another set at the border of a time-limited sequence 14 of signals. The human (or mammal) sensory system will interpret the composite repeated signal sequences 14 as composed by perceived signal sequences 18AJ extending over several sequence intervals 14. Someone listening to the repeated signal will be given the impression of a continuous composite signal sequence 22, which has the property of exhibiting an infinitely (imaginary) retardation.

In order to reduce any influence of the boundary between two consecutive time-limited signal sequences 14, signal element timing in the beginning of the time-limited signal sequence 14 and in the end of the time-limited signal sequence 14 should be fitted in such a way that the general pace is not influenced in any significant degree. More particularly, the signal element set should preferably be constituted such that a sum of a time difference between a last signal element 15A of a first set of signal elements and an end of the time-limited sequence 14 of signals, and a time difference between a beginning of the time-limited sequence 14 of signals and a first signal element 15B of a second set of signal elements is close to a time difference 16B between a first pair of signal elements of the second set of signal elements. In other words, the joint between two time-limited sequences of signals should present a pace that fits into the general trend.

When the intervals of a perceived signal sequence 18A-J become too long for significantly contributing to the general perceived pace pattern, it is just omitted. A listener will, however, be fully occupied by the other sequences and will probably not even notice the absence. At the same time, “new” sequences are introduced. In order to make the introduction as unnoticed as possible, the introduction occurs at an amplitude that is below a perceptual threshold 20 for the mammal listening to the signal sequence 22.

The time-limited signal sequence can be repeated an arbitrary number of times, which allows for unlimited exposure durations. However, any portion of the total signal sequence gives an illusion or impression of perpetual decrease in pace. Such an illusion is confirmed by behavioral experiments with human participants, but is expected to occur for all other animals with a comparable auditory system, i.e., all mammals and probably many non-mammalian species too.

The length of the time-limited signal sequence 14 determines its rate of change. In the embodiment of FIG. 2B, a signal sequence 14 where every second signal element belongs to the lowest level set 12A is utilized. Depending on the desired rate of change in pace, the length of the time-limited signal sequence 14 is preferably selected according to:
2^{p}−2^{p-2},
where p is an integer that determines the rate of change, which results in signal sequences of 6, 12,24,48,96, . . . signal elements.

The ratio between intervals in the beginning of a time-limited sequence 14 and in the end of the time-limited sequence 14 is in the embodiment of FIG. 2B ideally ½. Ratios of n^{±1}, where n is an integer is to prefer in order to fuse the end of one time-limited signal sequence to the beginning of the next, without causing any perceived discontinuity. The “−” sign corresponds to accelerating sequences, discussed further below.

In the present embodiment, each sound event is assigned to a particular set according to:
set No=event No mod2^{p}, p=1, 2, 3, . . . ∞,
where “event No” is a consecutive number of all events within each time-limited sequence. Note that setNo ranges from 0 to p−1.

The amplitudes A of the embodiment of FIG. 2B are set to:

$$A = a \times \frac{set No \times sequence length + event No}{sequence length \times No of sets} ,$$

where “sequence length” is the total number of signal elements within each time-limited sequence, “No of sets” is the total number of sets within each time-limited sequence and a is the maximum amplitude.

An essentially linear relation between set No and amplitude, as in the previous formula and in FIGS. 2-4, might not be optimal for auditory stimulation, because sensitivity for sound is logarithmic. An efficient implementation of sound sequences for human listeners used the following formula, which in a preferred embodiment gives a proportion relative the maximum amplitude from almost 0 to 1. This amplitude distribution gives small amplitudes for sets with short intervals and large amplitudes for sets with long intervals, and moderately smaller amplitudes for events with shorter intervals within each set.

$$A = a \times log ( b - c cos ( π \times \frac{set No \times sequence length + event No}{sequence length \times No of sets} ) ) ,$$

where a is the maximum amplitude and b and c are constants, in the preferred embodiment set to 5.5 and 4.5, respectively.

The change in interval is preferably performed in a smooth manner. In the embodiment of FIG. 2B, the time between successive events is defined as:

$$Δ {t}_{event No} = \frac{2 Δ \hat{t}}{3} ( 1 + \frac{event No}{sequence length} ) ,$$

where

Δ\hat{t}

is the average interval in the time-limited sequence, i.e. the one corresponding with the two events in the centre of the sequence. Note that “event No” ranges from 0 to (sequence length-1).

In the present embodiment, each set combines with the closest higher set at each sequence border. However, there are also possible embodiments in which a set of signal elements transforms into another, non-adjacent set.

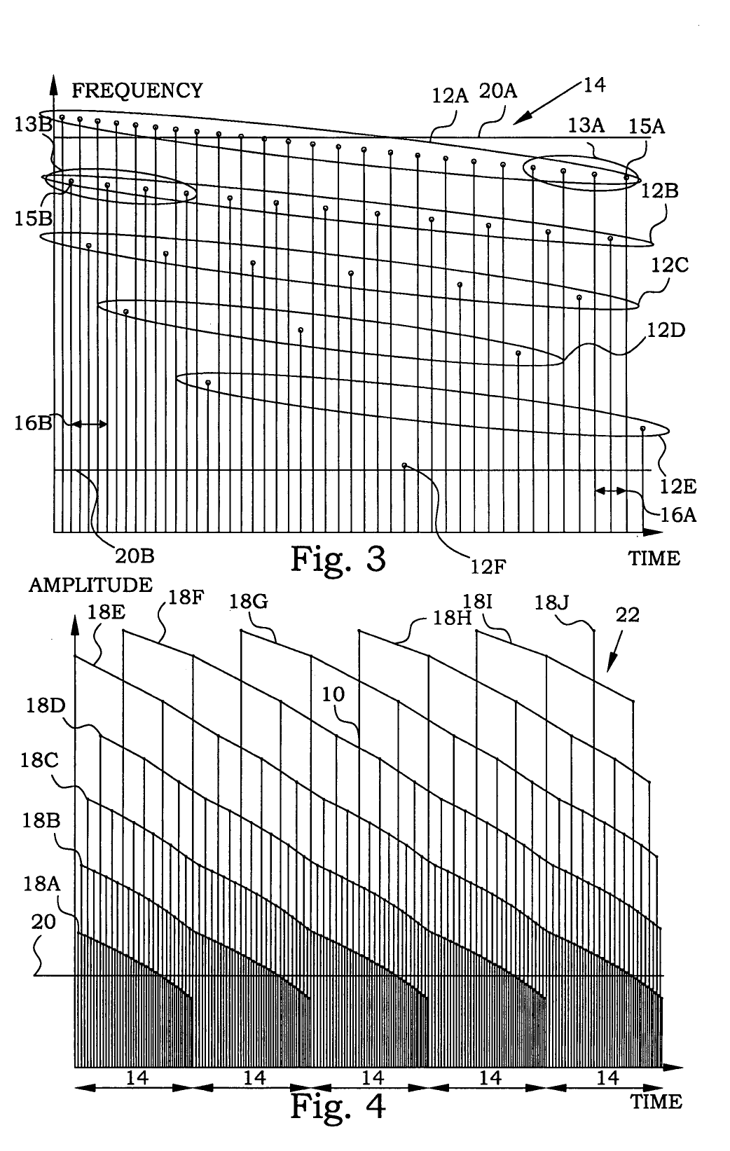

In the above embodiment, the signal elements of the different sets are partly characterized by the amplitude. However, the function performed by amplitude can be replaced by other signal element characteristics, such as, for example, frequency or frequency spectrum. The frequency of the signal element, or if a complex signal is used, the frequency spectrum can thus be used to separate signal elements of one set from signal elements of another set. In FIG. 3, a time-limited signal sequence 14 is illustrated as a diagram relating time and frequency. Here it can be seen that the signal element sets 12A-12F are introduced with a high frequency when their intervals are short, preferably above the hearing threshold 20A of the listener. When the intervals increase, the frequency of the signal elements is lowered and comes into the hearable region. At the other “end”, i.e. for long intervals, the frequency is dropped below or at least in the vicinity the lower hearable threshold 20B, which further reduces the possibility to notice the removal of the sequence.

Another signal element characteristic that can be used is stimulus event duration. Also more than one characteristic can be changed simultaneously. One non-exclusive example is both frequency and amplitude.

As mentioned above, the pace change could also be positive, i.e. an increasing pace, an accelerating or speeding-up signal sequence. An example of such a signal sequence 22 is illustrated in FIG. 4. Exposure of such a signal to mammals is believed to result in arousal effects. Here “new” perceived signal sequences 18A-J with long intervals are inserted, and are removed when their intervals have decreased. Preferably, the signal becomes imperceptible before being removed, in the present embodiment by crossing the perceptual threshold 20. In other words, characteristics, in this embodiment signal amplitude, for a set of signal elements that is going to be removed after the present time-limited sequence starts at perceptible levels at the beginning of the time-limited sequence. The characteristics, however, ends at imperceptible levels at the end of the time-limited sequence.

In the above embodiments, six sets of signal elements have been used. However, any number of sets, equal to or larger than two, is possible to use. The optimum number of sets depends strongly on the application, the type of signal, the type of signal characteristics that characterize the different sets, etc.

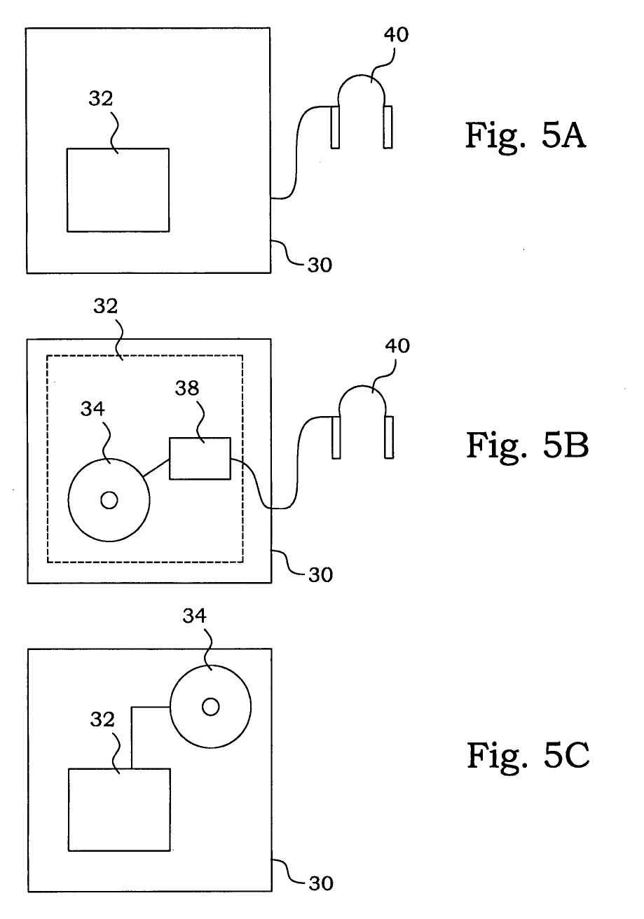

Signals of the above type can be provided in many different ways. The detailed configuration is, however, mainly determined by the type of signal that is used. In FIG. 5A, a block diagram of an acoustical signal generator 30 is illustrated. A generator 32 of repeated time-limited signal sequences according to the above principles provides electrical signals representing the intended acoustical signals. These electrical signals are transferred to a set of loudspeakers, in the present embodiment in the form of a headset 40, in which the electrical signal is transformed into an acoustical signal. The generator is in the present embodiment a processor providing a predetermined signal sequence. The detailed implementation of the generator 32 as such is known by anyone skilled in the art and will not be further described.

In FIG. 5B, another embodiment of an acoustical signal generator is illustrated. In this embodiment, the generator 32 comprises a compact disk (CD) having a representation of the intended acoustical signals recorded thereon in a digital form. When a CD-player 38, acting as a signal retrieving means, reads the content of the CD, appropriate signals for provision to the headset 40 are provided. Also here, the functions as such of the different components as such are known by anyone skilled in the art.

In one aspect of the present invention, the signal sequence according to the above presented principles can be provided for being stored in a memory device while waiting for the actual use. FIG. 5C illustrates a block diagram of such an embodiment. A generator 32 provides the signal sequences, which are subsequently stored in a memory device 34, in this embodiment a CD.

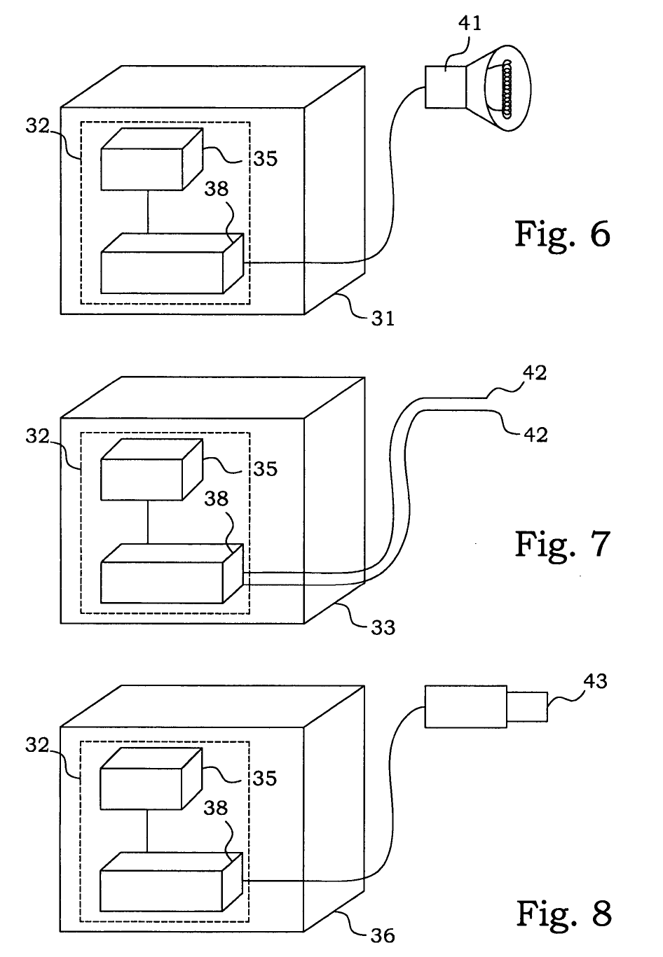

FIG. 6 illustrates an embodiment of a light signal generator 31 according to the present invention. A generator 32 comprises a memory device 35, in this embodiment a digital data storage. A processor 38 retrieves the data stored in the memory device 35 and provides appropriate currents to a lamp 41.

FIG. 7 illustrates an embodiment of an electrical signal generator 33 according to the present invention. A generator 32 comprises a memory device 35. A processor 38 retrieves the data stored in the memory device 35 and provides appropriate voltages to two electrodes 42.

FIG. 8 illustrates an embodiment of a tactile signal generator 36 according to the present invention. A generator 32 comprises a memory device 35. A processor 38 retrieves the data stored in the memory device 35 and provides appropriate control signals to a piston device 43.

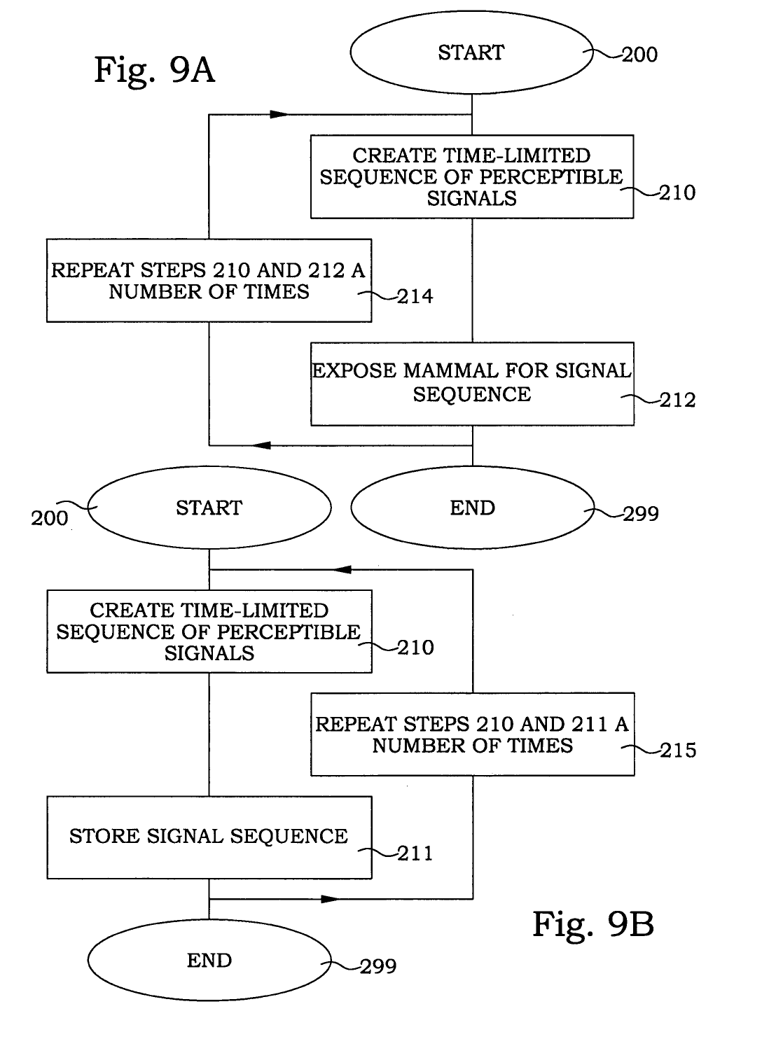

FIG. 9A illustrates main steps of an embodiment of a method according to the present invention. The procedure starts in step 200. In step 210, a time-limited sequence of perceptible signals is created, having the properties described above. In step 212, a mammal is exposed for the signal sequence.

As indicated by step 214, the steps 210 and 212 are repeated a number of times in order to provide a signal sequence of a considerable length. The procedure is ended in step 299.

When mammals are exposed to the created signal sequence, two groups of subjects are distinguished. In a first group, a certain disease is diagnosed, e.g. stress disorder. The method may then be used for therapeutic purposes. In other circumstances, the disease itself may not be affected by the exposure to signal sequences, however, the exposure is used in preparation for dedicated therapeutic procedures, such as e.g. reducing anxiety or pain. For example, music and other relaxation techniques are used to facilitate debridement of burn patients (Barker, 1991) and diagnosis of coronary heart conditions (Guzzetta, 1989).

A second group of subjects comprises mammals having no particular diagnosed disease. The exposure for signal sequences according to the above principles is then serving for general relaxing or arousal purposes. In this category, one may find persons seeking relaxing from normal life, i.e. for typical non-therapeutic purposes. Also e.g. athletes, preparing for different types of sports events belong to this category.

FIG. 9B illustrates main steps of another embodiment of a method according to the present invention. The procedure starts in step 200. In step 210, a time-limited sequence of perceptible signals is created, having the properties described above. In step 211, the created signal sequence is stored in a memory device. As indicated by step 215, the steps 210 and 211 are repeated a number of times in order to provide a signal sequence of a considerable length. The procedure is ended in step 299.

The embodiments described above are to be understood as a few illustrative examples of the present invention. It will be understood by those skilled in the art that various modifications, combinations and changes may be made to the embodiments without departing from the scope of the present invention. In particular, different part solutions in the different embodiments can be combined in other configurations, where technically possible. The scope of the present invention is, however, defined by the appended claims.

What is claimed is:

1. A signal generator comprising:
a signal generator of a repeated time-limited sequence of perceptible signals;
said time-limited sequence of perceptible signals having at least a first set of signal elements and a second set of signal elements, exclusive to but interleaved and/or overlaid with said first set of signal elements;
a majority of said signal elements of said first set of signal elements occurring at continuously and monotonically changing intervals within said time-limited sequence of perceptible signals;
a majority of said signal elements of said second set of signal elements occurring at continuously and monotonically changing intervals within said time-limited sequence of perceptible signals;
a general trend of signal element characteristics and intervals of said signal elements of said first set in an end part of said time-limited sequence of perceptible signals being similar to a general trend of signal element characteristics and intervals of said signal elements of said second set in a beginning part of said time-limited sequence of perceptible signals.

2. The signal generator according to claim 1, further comprising a ratio between a time difference between a first pair of signal elements of said first set and of said second set is essentially equal to n^{±1}, where n is an integer.

3. The signal generator according to claim 1 further comprising said signal elements of said first set of signal elements have continuously changing characteristics within said time-limited sequence of perceptible signals; and
said signal elements of said second set of signal elements have continuously changing characteristics within said time-limited sequence of perceptible signals.

4. The signal generator according to claim 1 wherein said characteristics are selected as at least one item from the list of:
frequency;
frequency spectral distribution;
time duration; and
amplitude.

5. The signal generator according to claim 1, wherein said continuously and monotonically changing intervals of said first set of signal elements and of said second set of signal elements increase, said characteristics for said first set of signal elements starts at imperceptible levels at the beginning of said time-limited sequence of perceptible signals and ends at perceptible levels at the end of said time-limited sequence of perceptible signals.

6. The signal generator according to claim 1, wherein said continuously and monotonically changing intervals of said first set of signal elements and of said second set of signal elements decreases, said characteristics for said second set of signal elements starts at perceptible levels at the beginning of said time-limited sequence of perceptible signals and ends at imperceptible levels at the end of said time-limited sequence of perceptible signals.

7. The signal generator according to claim 1 wherein said generator is a generator of audio, electromagnetic, mechanical or electrical signals or a combination thereof.

8. The signal generator according to claim 1 wherein said generator in turn comprises:
a memory device having a representation of said repeated time-limited sequence of perceptible signals stored therein; and
means for retrieving said repeated time-limited sequence of perceptible signals from said memory device.

9. The signal generator according to claim 1 further comprising a memory device arranged for storing a representation of said repeated time-limited sequence of perceptible signals.

10. The signal generator according to claim 1 further comprising means for exposing a mammal to said perceptible signals.

11. A time-limited sequence of perceptible signals, having at least a first set of signal elements and a second set of signal elements, exclusive to but interleaved and/or overlaid with said first set of signal elements;
a majority of said signal elements of said first set of signal elements occurring with continuously and monotonically changing intervals within said time-limited sequence of perceptible signals;
a majority of said signal elements of said second set of signal elements occurring with continuously and monotonically changing intervals within said time-limited sequence of perceptible signals;
a general trend of signal element characteristics and intervals of said signal elements of said first set in an end part of said time-limited sequence of perceptible signals being similar to a general trend of signal element characteristics and intervals of said signal elements of said second set in a beginning part of said time-limited sequence of perceptible signals.

12. The time sequence of perceptible signals of claim 11 further comprising a storage of the perceptible signals on a memory device.

13. The time-sequence of perceptible signals of claim 12, wherein the memory device is an audio signal memory device.

14. A method for generating perceptible signals comprising the step of:
repeating a time-limited sequence of perceptible signals;
said time-limited sequence of perceptible signals have at least a first set of signal elements and a second set of signal elements exclusive to but interleaved and/or overlaid with said first set of signal elements;
a majority of said signal elements of said first set of signal elements occurring with continuously and monotonically changing intervals within said time-limited sequence of perceptible signals;
a majority of said signal elements of said second set of signal elements occurring with continuously and monotonically changing intervals within said time-limited sequence of perceptible signals;
a general trend of signal element characteristics and intervals of said signal elements of said first set in an end part of said time-limited sequence of perceptible signals being similar to a general trend of signal element characteristics and intervals of said signal elements of said second set in a beginning part of said time-limited sequence of perceptible signals.

15. The method of claim 14 further comprising the steps of:
non-therapeutically treating a mammal by exposing the mammal to said perceptible signals.

16. The method of claim 14 further comprising the steps of:
treating mammals by exposing the mammals to said perceptible signals.
